(19) United States
(12) Patent Application Publication
(10) Pub. No.: US 2017/0125914 A1
(43) Pub. Date: May 4, 2017

(54) MULTIPLE NON-ORTHOGONAL METALLIC RECEIVERS FOR PARABOLIC DISH APPARATUS AND SYSTEM

(71) Applicant: CyberTAN Technology, Inc., Hsinchu (TW)

(72) Inventor: JENN-CHORNG LIOU, Hsinchu (TW)

(21) Appl. No.: 15/336,814

(22) Filed: Oct. 28, 2016

Related U.S. Application Data
(60) Provisional application No. 62/247,762, filed on Oct. 29, 2015.

(51) Int. Cl. H01Q 15/16; H01Q 21/24

(52) U.S. Cl. CPC H01Q 15/16; H01Q 21/24

(57) ABSTRACT

An antenna apparatus includes a parabolic dish and a receiver located at the focal point or multiple receivers nearby the focal point. In the one receiver case the receiver includes multiple receiving elements with a common adjacent angle around the axis of the parabolic dish, to create an array of antenna with different polarizations. In the multiple receiver case each receiver includes multiple receiving elements that create an array of antenna with different polarizations. The receiving elements transmit and receive non-orthogonal electromagnetic waves. The receiver(s) may include a reflector located next to the receiver which becomes an antenna resonator. The reflector enhances the transmitting gain by reflecting the electromagnetic waves. The receiving elements transmit and receive the electromagnetic waves using MIMO technology.

### FIELD

The disclosure relates to wireless communications and metallic receivers in antenna systems.

### BACKGROUND

Modern wireless communication networks count on a technology known as multiple-input-multiple-output (MIMO) to achieve greater data throughput. MIMO relies on multiple antennas to create space diversity and to exploit multiple electromagnetic transmission paths. This enhances transmission reliability.

Multiple antennas can be designed to create independent polarization channels according to the orientations of polarized signals. In a long distance communication network, the pair of transmitting and receiving antennas are usually in a dual-polarized configuration because orthogonal polarization of electromagnetic signals provides good isolations, or space diversity. Well-isolated electromagnetic waves facilitate a successful 2×2 MIMO communication and the throughput is usually doubled as compared to a single polarization link.

### BRIEF DESCRIPTION OF THE DRAWINGS

Implementations of the present technology will now be described, by way of example only, with reference to the attached figures, wherein:

FIG. 1 illustrates an antenna according to an embodiment of the present disclosure;

FIG. 2A illustrates a receiver of the antenna of FIG. 1 which includes multiple receiving elements according to an embodiment of the present disclosure;

FIG. 2B illustrates another receiver of the antenna of FIG. 1 which includes multiple receiving elements according to an embodiment of the present disclosure;

FIG. 3A illustrates the antenna system according to an embodiment of the present disclosure;

FIG. 3B illustrates another antenna system according to an embodiment of the present disclosure;

FIG. 4 is a block diagram of an antenna system according to an embodiment of the disclosure;

FIG. 5A illustrates an antenna according to an embodiment of the present disclosure;

FIG. 5B illustrates an antenna side view according to an embodiment of the present disclosure;

FIG. 6 illustrates multiple receivers of the antenna according to an embodiment of the present disclosure;

FIG. 7 illustrates multiple receivers of the antenna according to another embodiment of the present disclosure;

FIG. 8 illustrates the antenna system according to an embodiment of the present disclosure;

FIG. 9 illustrates the antenna system according to another embodiment of the present disclosure; and

FIG. 10 is a block diagram of an antenna system according to another embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. The term “comprising,” when utilized, means “including, but not necessarily limited to”; it specifically indicates open-ended inclusion or membership in the so-described combination, group, series, and the like. References to “an” or “one” embodiment in this disclosure are not necessarily to the same embodiment, and such references mean “at least one.”

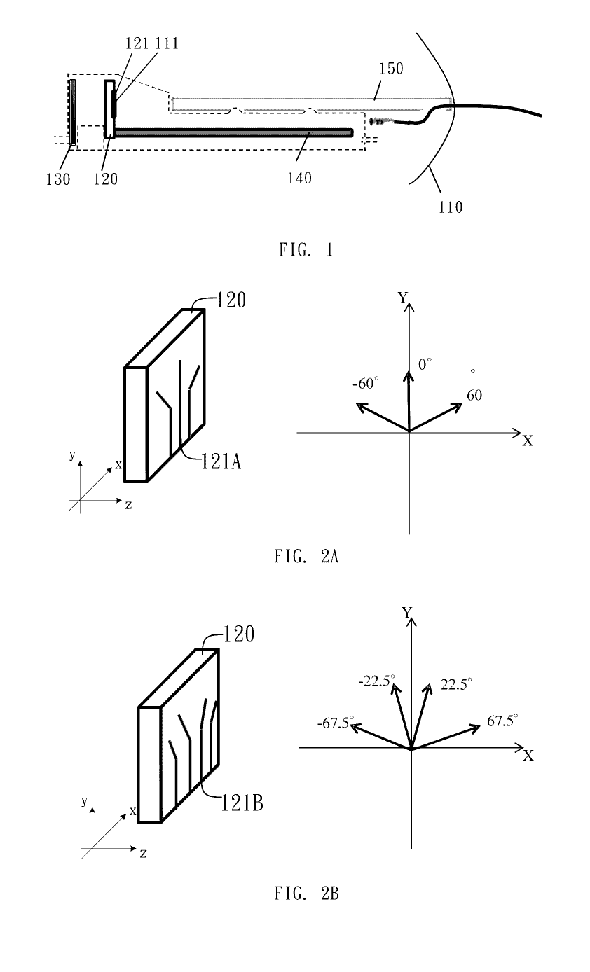

FIG. 1 shows an antenna according to an embodiment of the disclosure. The antenna comprises a parabolic dish 110, a receiver 120, receiving elements 121, a reflector 130, a printed circuit board 140, and a holder 150.

The parabolic dish 110 is a conductive parabolic reflector which comprises a focal point 111, wherein the parabolic dish 110 reflects impinging electromagnetic waves to the receiver 120 located at the focal point 111. Generally speaking, a larger parabolic dish imply a larger reflecting area, and a higher gain is thus obtained. The electromagnetic waves reflected by a parabolic dish antenna have characteristics of narrow beam width and high transmission gain. The parabolic dish antenna can be used in point-to-point long distance communication. Using the parabolic dish antenna to receive electromagnetic waves, the transmission distance can reach 25 miles if there is no obstacle in between. The parabolic dish antenna is one kind of high gain directional antenna.

The receiver 120 comprises a plurality of receiving elements 121 located at the focal point 111. The receiving elements 121 are installed in different radial angles around a receiving axis of the parabolic dish 110 with the same angular interval between neighboring receiving elements 121 for transmitting or receiving electromagnetic waves. In one embodiment, the polarization of each of the receiving element is not orthogonal against others. The reflector 130 is located next to the receiver 120. The reflector 130 enhances transmitting gain by reflecting the electromagnetic waves to the receiving elements 121 and is therefore part of an antenna resonator design. The printed circuit board 140 is electrically connected to the antenna. The printed circuit board 140 is used as a base board mounted on the holder 150. The holder 150 is installed along the receiving axis of the parabolic dish 110. The receiver 120 is electrically connected to the printed circuit board 140. In an exemplary embodiment, the ‘receiving axis’ of the parabolic dish is to mean the axis for impinging receiving electromagnetic waves. When the parabolic dish 110 is a central focal dish, the focal point 111 and the receiving axis are co-located at a central axis of the parabolic dish 110. When the parabolic dish 110 is an offset focal dish, there will be an angle between the receiving axis of the incoming electromagnetic wave and the central axis of the parabolic dish 110, so as the propagation axis of the reflected wave where focal point sits on. In this work the central focal dish is being used as the exemplary case wherein the receiving axis of the incoming electromagnetic wave coincide with the propagation axis of the reflected wave from the parabolic dish. Those skilled in this art can easily extend the configuration created herein to the case of offset focal dish.

FIG. 2A shows the receiver 120 according to an embodiment of the disclosure, wherein the receiver 120 comprises a plurality of the receiving elements 121.

The antenna picks up electromagnetic waves energy in interactive electric field and magnetic field to accomplish a wireless radio link. The polarization of each of the receiving elements 121 must therefore be aligned to the polarization of the electromagnetic wave it intends to receive. An electromagnetic wave with horizontally aligned electric field is called horizontally polarized wave. An electromagnetic wave with vertically aligned electric field is called vertically polarized wave. Polarizations of electromagnetic waves can be controlled by changing the orientations of the receiving elements 121. Although the incoming electromagnetic waves may come from all directions, only those electric fields in line with the electric field of the receiving element can be picked up most efficiently. Linearly polarized electromagnetic waves are used as the examples throughout this work although other types of polarizations can work similarly for those skilled in this art. By using a parabolic dish, the receiving elements 121 installed at the focal point 111 of the parabolic dish 110 make multiple narrow beams of electromagnetic wave in their polarizations with high gains. This kind of antenna is often used in a point-to-point network over long distance communications. For the same distance of communication, the parabolic dish antenna can replace the coaxial cable or optical fiber.

As shown in FIG. 2A, receiving elements 121A are installed in three different radial angles around the receiving axis of the parabolic dish (the Z-axis in a Cartesian coordinate system) according to an embodiment of the disclosure. The positive half of the Y-axis is defined as radial angle degree 0. The three receiving elements 121A are installed in degree 0, degree 60, and degree −60 radial angles separately, making the angular interval between neighboring receiving elements 121A degree 60. The multiple receiving elements 121A are installed in such radial angles so that electromagnetic waves of different polarizations are received and transmitted in their respective geometric orientations. The present disclosure is not intended be limited to the particular embodiment or radial angles disclosed. All embodiments or radial angles falling within the scope of the appended claims are to be included. The multiple receiving elements 121A use MIMO technology to transmit and receive the electromagnetic waves, wherein each of the receiving elements 121A independently transmits and receives the data stream in its geometric orientation. Degree 60 angular spacing maximizes isolations, or space diversity, when three sets of electromagnetic waves propagate in the same direction.

FIG. 2B shows the receiver 120 according to another embodiment of the disclosure. As shown in FIG. 2B receiving elements 121B according to an embodiment of the disclosure are installed in four different radial angles around the receiving axis of the parabolic dish (Z-axis). The four receiving elements 121B are installed in radial angles degree 22.5, degree 67.5, degree −22.5, and degree −67.5 separately, making the angular interval between neighboring receiving elements 121B degree 45. The four receiving elements 121B installed in such radial angles so that electromagnetic waves of four polarizations are received and transmitted in their respective geometric orientations. The four receiving elements 121B use MIMO technology to transmit and receive the electromagnetic waves, wherein each of the receiving elements 121B independently transmits and receives the data stream in its geometric orientation. Degree 45 angular spacing maximizes isolations, or space diversity, when four sets of electromagnetic waves propagate in the same direction.

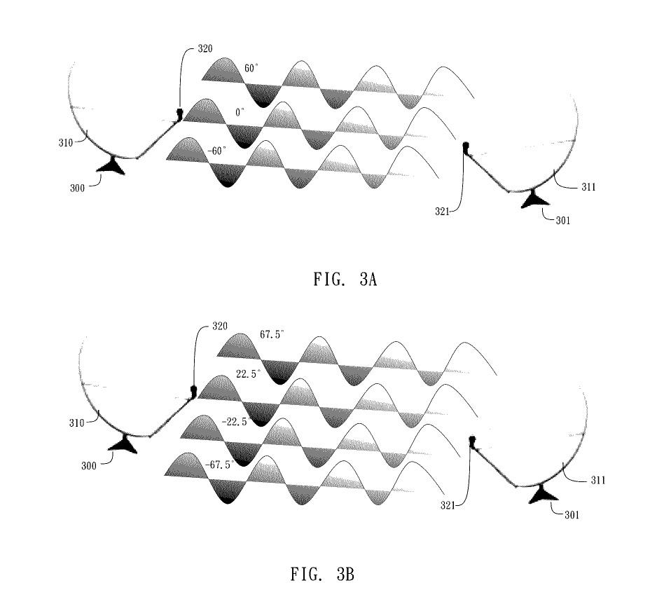

FIG. 3A shows an antenna system according to an embodiment of the disclosure. As shown in FIG. 3A, the antenna system comprises a first antenna 300 and a second antenna 301. The first antenna 300 comprises a first parabolic dish 310 and a first receiver 320, wherein the first receiver 320 comprises a plurality of first receiving elements (in the same configuration as the receiving elements 121A) installed at a first focal point. The first antenna 300 transmits non-orthogonal polarized electromagnetic waves to the second antenna 301. The second antenna 301 comprises a second parabolic dish 311 and a second receiver 321, wherein the second receiver 321 comprises a plurality of second receiving elements (in the same configuration as the receiving elements 121A) installed at the second focal point. The second antenna 301 receives the non-orthogonal polarized electromagnetic waves from the first antenna 300. As shown in FIG. 3A, the first receiver 320 transmits electromagnetic waves to the second receiver 321 in three (linear) polarizations degree 0, degree 60, and degree −60. The angular interval between neighboring polarizations is thus degree 60.

FIG. 3B shows the antenna system according to another embodiment. The set of first receiving elements transmit electromagnetic waves with different polarizations. The number of the polarizations depends on the number of the first receiving elements. As shown in FIG. 3B, the first receiver 320 transmits electromagnetic waves to the second receiver 321 in four (linear) polarizations degree 67.5, degree 22.5, degree −22.5 and degree −67.5. The second receiver 321 comprises a corresponding number of the second receiving elements (four receiving elements in this embodiment). The angular interval between neighboring polarizations is thus degree 45.

In an embodiment, the first receiving elements and the second receiving elements are installed in multiple radial angles with the same angular interval. It is intended that the disclosure not be limited to the particular embodiment disclosed but that the disclosure will include any angular interval and varied angular within the scope of the appended claims.

In an embodiment, the first antenna 300 and the second antenna 301 further comprises a first reflector located next to the first receiver 320 and a second reflector located next to the second receiver 321, wherein the first reflector and the second reflector create additional transmitting gain by reflecting the electromagnetic waves.

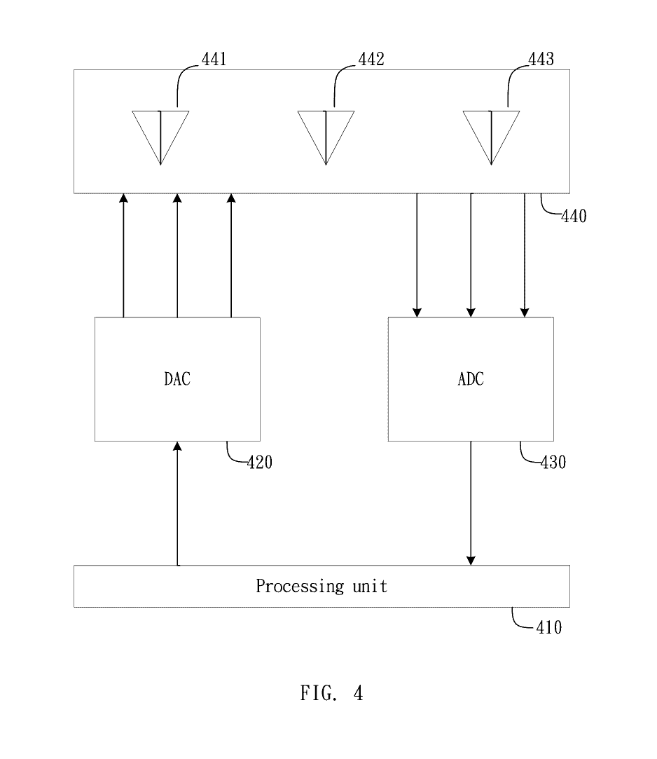

FIG. 4 shows a block diagram of the antenna according to an embodiment of the disclosure. As shown in FIG. 4, the antenna comprises a processing unit 410, a digital/analog converter 420, an analog/digital converter 430, and a multi-polarized antenna 440. The multi-polarized antenna 440 comprises a first polarized receiving-element 441, a second polarized receiving-element 442, and a third polarized receiving-element 443.

The processing unit 410 processes data streams for multiple independent channels. The number of independent channels depends on the number of polarized receiving elements in the multi-polarized antenna 440. FIG. 4 shows three independent channels in the embodiment of the disclosure. Each channel transmits and receives electromagnetic waves by independently using a corresponding polarized receiving element. In a radio communication system the same receiving element can be dual-used as the transmitting and receiving antenna, wherein usually diplexers or splitters (not shown) are used to split transmitting and receiving signals. The processing unit 410 creates data streams needed and delivers to the digital/analog converter 420. The digital/analog converter 420 converts the digital signals for three specified channels to three separate paths of analog signals, i.e. a first output signal, a second output signal, and a third output signal. After frequency conversion and power amplification (functional blocks not shown), the radio signal is delivered to the receiving element with the corresponding polarization. The first output signal is transmitted by a first polarized receiving element 441, the second output signal is transmitted by a second polarized receiving element 442, and the third output signal is transmitted by a third polarized receiving-element 443.

The multi-polarized antenna 440 can receive the electromagnetic waves. With proper alignment of polarizations the first receiving element 441 receives the first input signal, the second receiving element 442 receives the second input signal, and the third receiving element 443 receives the third input signal. After power amplification and the frequency conversion (functional blocks not shown), the analog/digital converter 430 converts the first output signal, the second output signal and the third output signal into respective digital signals, and be further delivered to the processing unit 410 to recover the data streams.

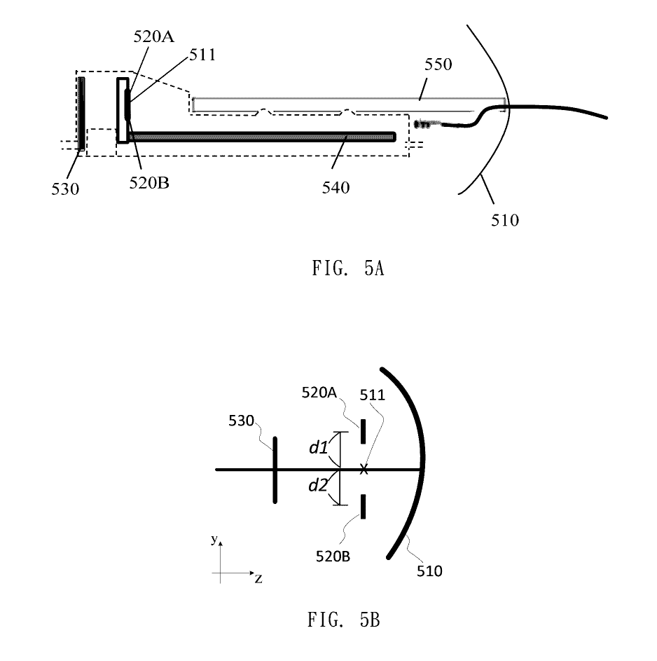

FIG. 5A shows another antenna design according to an embodiment of the disclosure. As shown in FIG. 5A, the antenna comprises a parabolic dish 510, a first receiver 520A, a second receiver 520B, a reflector 530, a print circuit board 540, and a holder on axis 550.

The parabolic dish 510 comprises a focal point, wherein the parabolic dish 510 reflects impinging electromagnetic waves to the focal point 511. The reflector 530 enhances transmitting gain by reflecting the electromagnetic waves to the first receiver 520A and the second receiver 520B and is therefore part of an antenna resonator design. The printed circuit board 540 is electrically connected to the antenna. The printed circuit board 540 is used as a base board mounted on the holder 550. The holder 550 is installed along the receiving axis of the parabolic dish 510. When the parabolic dish 510 is a central focal dish, the focal point 511 and the receiving axis are co-located at a central axis of the parabolic dish 510. When the parabolic dish 510 is an offset focal dish, there will be an angle between the receiving axis of the incoming electromagnetic wave and the central axis of the parabolic dish 510, so as the propagation axis of the reflected wave where focal point sits on. In this work the central focal dish is being used as the exemplary case, wherein the receiving axis of the incoming electromagnetic wave coincides with the propagation axis of the reflected wave from the parabolic dish 510. Those skilled in this art can easily extend the configuration created herein to the case of offset focal dish.

FIG. 5B illustrates the side view according to an embodiment of the present disclosure. As shown in FIG. 5B, the receiving axis of the parabolic dish 510 is coincidence to the Z-axis. The first receiver 520A and the second receiver 520B are installed at a first distance d1 and a second distance d2 away from the focal point 511 to receive the electromagnetic wave in the vicinity of the focal point 511, where the first distance d1 can be equal to the second distance d2 (only as an example). For optimized isolation between the first receiver 520A and the second receiver 520B, the sum of the first distance d1 and the second distance d2 can roughly be equal to one wavelength (λ) of the electromagnetic wave (not to be limited).

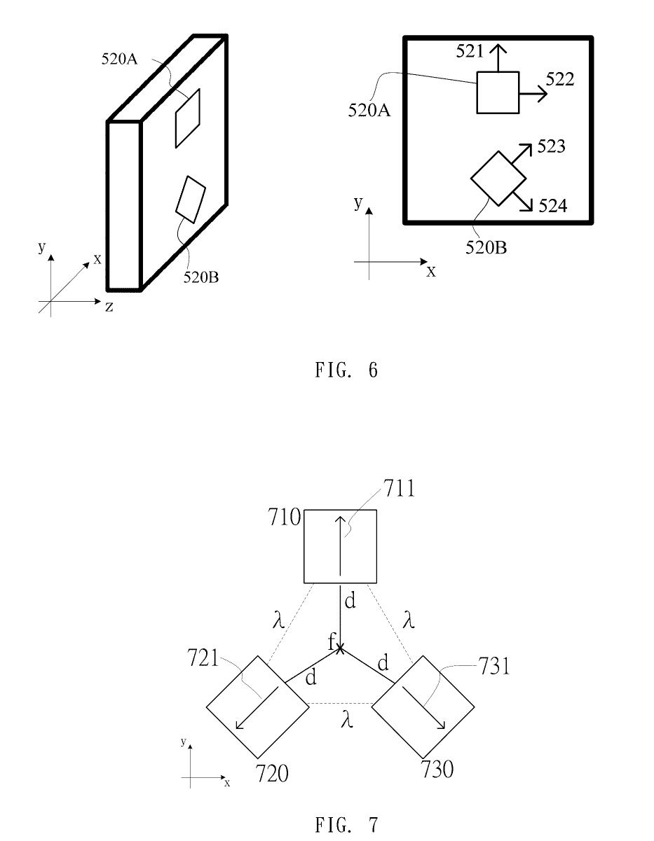

FIG. 6 illustrates an antenna according to an embodiment of the present disclosure. As shown in FIG. 6, the first receiver 520A and the second receiver 520B are installed on the X-Y plane where focal point 511 sits. In an embodiment, the first receiver 520A comprises a first receiving element and a second receiving element (not shown). The first receiving element receives first electromagnetic waves, wherein the first electromagnetic waves are polarized in a first polarization 521. The second receiving element receives second electromagnetic waves, wherein the second electromagnetic waves are polarized in a second polarization 522. For optimized isolation the first polarization 521 is orthogonal with the second polarization 522, pointing to degree 0 and degree 90 separately on the x-y plane. The second receiver 520B comprises a third receiving element and a fourth receiving element (not shown). The third receiving element receives third electromagnetic waves, wherein the third electromagnetic waves are polarized in a third polarization 523. The forth receiving element receives fourth electromagnetic waves and the fourth electromagnetic waves are polarized in a fourth polarization 524. For optimized isolation the third polarization 523 is orthogonal with the fourth polarization 524, pointing to degree 45 and degree 135 separately on the x-y plane. Degree 45 angular spacing maximizes isolations, or space diversity, when four sets of electromagnetic waves propagate in the same direction. The number of receivers is not limited to two. In practice it can be more than two.

FIG. 7 illustrates another antenna design according to an embodiment of the present disclosure. As shown in FIG. 7, an antenna comprises a focal point f, a first receiver 710, a second receiver 720, and a third receiver 730 installed on the X-Y plane where the focal point f sits. In an embodiment, the first receiver 710 comprises a first receiving element to receive first electromagnetic waves in a first polarization 711, the second receiver 720 comprises a second receiving element to receive second electromagnetic waves in a second polarization 721, and the third receiver 730 comprises a third receiving element to receive third electromagnetic waves in a third polarization 731. The first receiver 710, the second receiver 720 and the third receiver 730 are located away from the focal point f by a physical distance d. For optimized isolation between each pair of neighboring receivers, the physical distance d is approximately a wavelength λ of the electromagnetic wave divided by √3 (d=λ/√3) (not to be limited). This is shown in FIG. 7. Also for optimized isolation, or space diversity, the angle between polarizations of neighboring receivers, being represented by the first polarization 711, the second polarization 721 and the third polarization 731, is roughly degree 120 (not to be limited). Degree 120 angular spacing maximizes isolations, or space diversity, when three sets of electromagnetic waves propagate in the same direction.

The antenna picks up electromagnetic waves energy in interactive electric field and magnetic field to accomplish a wireless radio link. The orientations of the first receiving element and the second receiving element in the first receiver 520A as well as the third receiving element and the fourth receiving element in the second receiver 520B must therefore be aligned to the polarization of the electromagnetic wave it intends to receive. Polarizations of electromagnetic waves can be controlled by changing the orientations of the receiver 520A and the receiver 520B. Although the incoming electromagnetic waves may come from all directions, only those electric fields in line with the electric field of the receiving element can be picked up most efficiently. The first receiver 520A and the second receiver 520B located at the vicinity of the focal point 511 receive the electromagnetic wave reflected by the parabolic dish 510. The first receiving element receives the electromagnetic waves with the first polarization 521, the second receiving element receives the electromagnetic waves with the second polarization 522, the third receiving element receives the electromagnetic waves with the third polarization 523, and the fourth receiving element receives the electromagnetic waves with the fourth polarization 524. Degree 45 angular spacing as is indicated in FIG. 6 is an optimization in theory. As a general case, space diversity exists as long as the first polarization 521 and the third polarization 523 are neither parallel nor orthogonal.

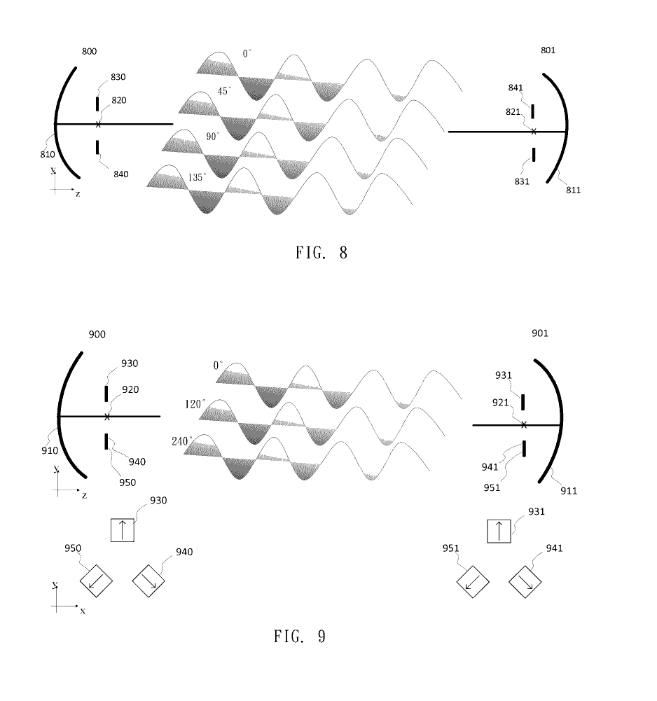

FIG. 8 illustrates an antenna system according to an embodiment of the present disclosure. As shown in FIG. 8, an antenna system comprises a first antenna 800 and a second antenna 801. The first antenna 800 comprises a first parabolic dish 810, a first focal point 820, a first receiver 830, and a second receiver 840. The first receiver 830 and the second receiver 840 are in the same design as the first receiver 520A and the second receiver 520B in FIG. 6. The first antenna 800 transmits electromagnetic waves to the second antenna 801. The second antenna 801 comprises a second parabolic dish 811, a second focal point 821, a third receiver 831 and a fourth receiver 841. The third receiver 831 and the forth receiver 841 are in the same design as the first receiver 520A and the second receiver 520B in FIG. 6. The second antenna 801 receives electromagnetic waves from the first antenna 800. The third receiver 831 receives the electromagnetic waves from the first receiver 830 with polarizations oriented in degree 0 and degree 90. The fourth receiver 841 receives the electromagnetic waves from the second receiver 840 with polarizations oriented in degree 45 and degree 135. The first receiver 830, the second receiver 840, the third receiver 831, and the fourth receiver 841 use MIMO techniques to transmit and receive the electromagnetic waves. The first electromagnetic waves carries a first data stream, the second electromagnetic waves carries a second data stream, the third electromagnetic waves carries a third data stream, and the fourth electromagnetic waves carries a fourth data stream, wherein each of the receiving elements independently transmits and receives the data stream in its geometric orientation. Although first receiver 830, the second receiver 840, the third receiver 831, and the fourth receiver 841 maintain certain physical distances from their first focal point 820 and second focal point 821, resulting degradation of focal efficiency, experiment confirmed that overall diversity gain surpasses the loss in focal efficiency, creating improved data throughputs.

In an embodiment, the first receiver 830 and the second receiver 840 are installed in non-orthogonal orientations. The embodiments shown and described above are only examples, but not limited. The first receiver 830 and the second receiver 840 can be installed in any orientation depends on application environment.

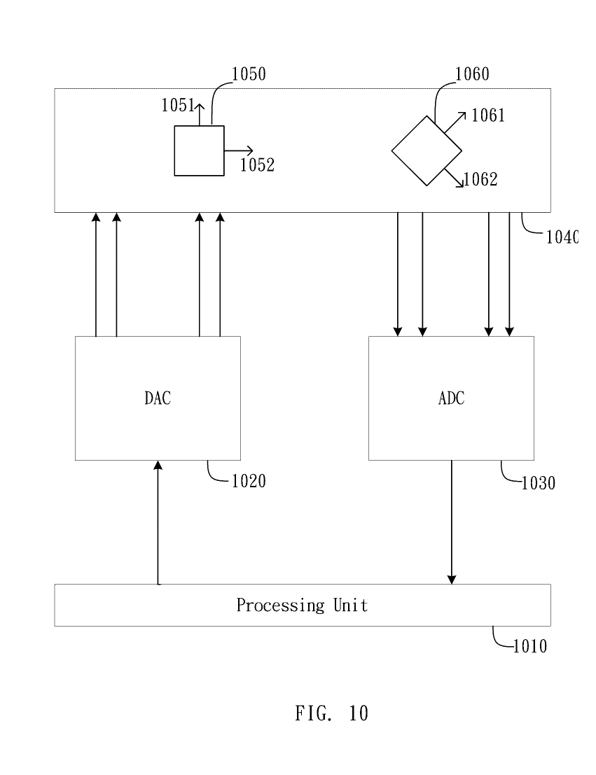

FIG. 9 illustrates an antenna system according to another embodiment of the present disclosure. As shown in FIG. 9, an antenna system comprises a first antenna 900 and the second antenna 901. The first antenna 900 comprises a first parabolic dish 910, a first focal point 920, a first receiver 930, a second receiver 940, and a third receiver 950. The first receiver 930 transmits and receives the first electromagnetic wave, the second receiver 940 transmits and receives the second electromagnetic wave, and the third receiver 950 transmits and receives the third electromagnetic wave. For optimized isolation between the neighboring pairs among the first receiver 930, the second receiver 940, and the third receiver 950, the gap between the adjacent receivers is roughly λ (wavelength) but is not limited to this. Also for improved space diversity the polarizations of the second receiver 940 and the third receiver 950 are separately rotated degree +120 and degree −120 against that of the first receiver 930. The second antenna 901 comprises a second parabolic dish 911, a second focal point 921, a fourth receiver 931, a fifth receiver 941, and a sixth receiver 951. With proper alignment in polarizations, the fourth receiver 931 transmits and receives the first electromagnetic waves from the first receiver 930, the fifth receiver 941 transmits and receives the second electromagnetic waves from the second receiver 940, and the sixth receiver 951 transmits and receives the third electromagnetic waves from the third receiver 950. Similar to the case of the first antenna 900, for optimized isolation among the neighboring pairs among the fourth receiver 931, the fifth receiver 941, and the sixth receiver 951, the gap between the adjacent receivers is roughly λ (wavelength) but is not limited to this. And the polarizations of the fifth receiver 941 and the sixth receiver 951 are separately rotated degree +120 and degree −120 against that of the fourth receiver 931 (not to be limited).

FIG. 10 is a block diagram of an antenna system according to another embodiment of the disclosure. As shown in FIG. 10, the antenna comprises a processing unit 1010, a digital/analog converter 1020, an analog/digital converter 1030, and a multi-polarized antenna 1040. The multi-polarized antenna 1040 comprises a first receiver 1050, and a second receiver 1060.

The processing unit 1010 processes data streams for multiple independent channels. The number of independent channels depends on the number of polarized receiving elements in the multi-polarized antenna 1040. FIG. 10 shows four independent channels in the embodiment of the disclosure. Each channel transmits and receives electromagnetic waves by independently using a corresponding polarized receiving element. In a radio communication system, the same receiving element can be dual-used as the transmitting and receiving antenna, wherein usually diplexers or splitters (not shown) are used to split transmitting and receiving signals. The processing unit 1010 creates the digital streams and delivers to the digital/analog converter 1020. The digital/analog converter 1020 converts the digital signals for four specified channels to four separate paths of analog signals, i.e. a first output signal, a second output signal, a third output signal, and a fourth output signal. After frequency conversion and power amplification (functional blocks not shown), the radio signal is delivered to the receiving element with the corresponding polarization. The first output signal is transmitted by a first polarized receiving element 1051, the second output signal is transmitted by a second polarized receiving element 1052, the third output signal is transmitted by a third polarized receiving-element 1061, and the fourth output signal is transmitted by a fourth polarized receiving-element 1062.

The multi-polarized antenna 1040 can receive the electromagnetic waves. With proper alignment of polarizations the first receiving element 1051 receives the first input signal, the second receiving element 1052 receives the second input signal, the third receiving element 1061 receives the third input signal, and the fourth receiving element 1062 receives the fourth input signal. After power amplification and the frequency conversion (functional blocks not shown), the analog/digital converter 1030 converts the first output signal, the second output signal, the third output signal, and the fourth output signal into respective digital signals, and be further delivered to the processing unit 1010 to recover the data streams.

Non-orthogonal polarized electromagnetic waves in the same frequency may interfere with each other. However, closely spaced sub-carriers can be mathematically orthogonal to each other if amplitudes and phases are carefully arranged. This is the so-called Orthogonal Frequency-Division Multiplexing (OFDM) in which digital data are encoded on multiple carrier frequencies, creating multiplied transmission capacity. In addition, MIMO arrangement has been proven to be an efficient way to deliver multiple streams using multiple antennas when space-diversified multiple paths are available. Nowadays MIMO-OFDM has become the dominant scheme for high bandwidth radio communications such as LTE and Wi-Fi.

For a point-to-point microwave link, two independently polarized waves (vertical or horizontal linearly polarized wave or left-handed or right-handed polarized wave) do provide good space diversity for a 2-stream MIMO. For MIMO streams greater than 2, electromagnetic waves not geometrically oriented orthogonally can still be used, with degraded benefit of space diversity. In this embodiment, multiple antenna receivers co-located at or nearby to the focal point 111 or 511 of a parabolic dish are proposed for a point-to-point MIMO-OFDM radio link. Co-located antenna receivers and receiving elements well arranged geometrically for the best use of polarization isolation are used as the antennas for space-diversified communications. The antenna and the antenna system transmit and receive electromagnetic waves in non-orthogonal polarizations according to an embodiment of the disclosure. Experiment confirms that with the number of non-orthogonal receiving elements being greater than two more than twice the throughput of single polarized electromagnetic waves can be achieved. This provides significant benefits to the bandwidth and quality of a radio link. Taking the advantage of modern MIMO technologies this creative way of space diversity does provide an innovative way to deliver multiple data streams in the air, enhancing the quality of long-distance point-to-point wireless communications.

The embodiments shown and described above are only examples. Therefore, many such details of the art are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An antenna, comprising:
a parabolic dish, wherein the parabolic dish comprises a focal point;
a receiver located at the focal point of the parabolic dish, wherein the receiver comprises a plurality of receiving elements configured to receive non-orthogonal polarized electromagnetic waves.

2. The antenna as claimed in claim 1, wherein the parabolic dish comprises an axis, and the receiving elements are installed in different radial angles around the axis with the same angular interval.

3. The antenna as claimed in claim 1, wherein the receiving elements transmit and receive the electromagnetic waves using MIMO technology, and the receiving elements carries data streams independently at the same time.

4. An antenna, comprising:
a parabolic dish, wherein the parabolic dish comprises a focal point;
a first receiver comprises a first receiving element to receive first electromagnetic waves polarized in a first polarization;
a second receiver comprises a second receiving element to receive second electromagnetic waves polarized in a second polarization;
a third receiver comprises a third receiving element to receive third electromagnetic waves polarized in a third polarization, and the first receiver, the second receiver and the third receiver are away from the focal point by a physical distance.

5. The antenna as claimed in claim 4, wherein the physical distance is a wavelength of electromagnetic waves divided by √3 (λ/√3) and the angular spacing between each pairs among the first electromagnetic waves, the second electromagnetic waves and the third electromagnetic wave is 120 degrees.

6. The antenna as claimed in claim 4, wherein the receiving elements transmit and receive the electromagnetic waves using MIMO technology, and the receiving elements carries data streams independently at the same time.

7. An antenna, comprising:
a parabolic dish, wherein the parabolic dish comprises a focal point;
a first receiver, comprising a first receiving element and a second receiving element to receive first electromagnetic waves, polarized in a first polarization, and second electromagnetic waves, polarized in a second polarization, wherein the first polarization is orthogonal to the second polarization, and
a second receiver, comprising a third receiving element and a fourth receiving element to receive third electromagnetic waves, polarized in a third polarization, and the fourth electromagnetic waves, polarized in a fourth polarization,
wherein the first receiver and the second receiver are away from the focal point by a physical distance, and the first polarization and the third polarization are neither parallel nor orthogonal.

8. The antenna as claimed in claim 7, wherein the physical distance is a half wavelength of electromagnetic waves (λ/2).

9. The antenna as claimed in claim 7 wherein the receiving elements transmit and receive the electromagnetic waves using MIMO technology, and the receiving elements carries data streams independently at the same time.

10. An antenna system, comprising:
a first antenna, comprising:
a first parabolic dish, wherein the first parabolic dish comprises a first focal point; and
a first receiver located at the first focal point, wherein the first receiver comprises a plurality of first receiving elements configured to receive non-orthogonal polarized electromagnetic waves; and
a second antenna, comprising:
a second parabolic dish, wherein the second parabolic dish comprises a second focal point; and
a second receiver located at the second focal point, wherein the second receiver comprises a plurality of second receiving elements configured to receive non-orthogonal polarized electromagnetic waves aligned to the polarizations of the plurality of first receiving elements.

11. The antenna system as claimed in claim 10, wherein the plurality of first receiving elements and their matching plurality of second receiving elements transmit and receive the electromagnetic waves using MIMO technologies, carrying data streams independently at the same time.

12. An antenna system, comprising:
a first antenna, comprising:
a first parabolic dish, wherein the first parabolic dish comprises a first focal point;
a first receiver transmitting first electromagnetic waves, polarized in a first polarization;
a second receiver transmitting second electromagnetic waves, polarized in a second polarization;
a third receiver transmitting third electromagnetic waves, polarized in a third polarization, wherein the first receiver, the second receiver and the third receiver are away from the first focal point by a first physical distance; and
a second antenna, comprising:
a second parabolic dish, wherein the second parabolic dish comprises a second focal point;
a fourth receiver, aligning to the first receiver to receive the first electromagnetic waves;
a fifth receiver, aligning to the second receiver to receive the second electromagnetic waves; and
a sixth receiver, aligning to the third receiver to receive the third electromagnetic waves;
wherein the fourth receiver, the fifth receiver and the sixth receiver are away from the second focal point by a second physical distance.

13. The antenna system as claimed in claim 12, wherein the first, second and the third receivers and their matching fourth, fifth and sixth receivers transmit and receive the electromagnetic waves using MIMO technologies, carrying data streams independently at the same time.

14. An antenna system, comprising:
a first antenna, comprising:
a first parabolic dish, wherein the first parabolic dish comprises a first focal point;
a first receiver, transmitting first electromagnetic waves, polarized in a first polarization, and second electromagnetic waves, polarized in a second polarization, and the first polarization is orthogonal to the second polarization; and
a second receiver, transmitting third electromagnetic waves, polarized in a third polarization, and fourth electromagnetic waves, polarized in a fourth polarization, and the third polarization is orthogonal to the fourth polarization, and the first receiver and the second receiver are away from the first focal point by a first physical distance; and
a second antenna, comprising:
a second parabolic dish, wherein the second parabolic dish comprises a second focal point;
a third receiver, aligning to the first receiver to receive the first electromagnetic waves and the second electromagnetic waves; and
a fourth receiver, aligning to the second receiver to receive the third electromagnetic waves and the fourth electromagnetic waves, wherein the third receiver and the fourth receiver are away from the second focal point by a second physical distance.

15. The antenna system as claimed in claim 14, wherein the first and second receivers and their matching third and fourth receivers transmit and receive the electromagnetic waves using MIMO technologies, carrying data streams independently at the same time.
